(19) United States
(12) Patent Application Publication
(10) Pub. No.: US 2026/0277075 A1
(43) Pub. Date: Sep. 17, 2026

(54) LENS DEVICE AND IMAGING APPARATUS

(71) Applicant: FUJIFILM Corporation, Tokyo (JP)

(72) Inventors: Nobuyuki KONDO, Saitama (JP); Yuichi KAWANABE, Saitama (JP)

(73) Assignee: FUJIFILM Corporation, Tokyo (JP)

(21) Appl. No.: 19/557,167

(22) Filed: Mar. 5, 2026

(30) Foreign Application Priority Data
Mar. 12, 2025 (JP) 2025-039557

(51) Int. Cl. G03B 5/02

(52) U.S. Cl. CPC G03B 5/02; G03B 2205/0046

(57) ABSTRACT

The lens device includes an optical system, a support member that supports the optical system, a movable member that is disposed along an outer periphery of the support member and that is movably supported with respect to the support member, and an engagement mechanism that engages with the movable member, in which the engagement mechanism is inclined with respect to a direction of an optical axis.

### CROSS-REFERENCE TO RELATED APPLICATIONS

This application claims priority under 35 USC 119 from Japanese Patent Application No. 2025-039557 filed on Mar. 12, 2025, the disclosure of which is incorporated by reference herein.

### BACKGROUND OF THE INVENTION

### 1. Field of the Invention

The technology of the present disclosure relates to a lens device and an imaging apparatus.

### 2. Description of the Related Art

JP2023-026223A discloses an optical apparatus including an operation ring that is operated by a user around an optical axis, a guide barrel that holds a lens group to be movable in an optical axis direction, a cam barrel that rotates around the optical axis in conjunction with the operation ring and that drives the lens group in the optical axis direction in cooperation with the guide barrel, and a click mechanism that locks the operation ring from rotating, in which a cam groove is provided in any one of the guide barrel or the cam barrel, a protrusion that engages with the cam groove is provided in any one of the guide barrel or the cam barrel other than the one on which the cam groove is provided, the cam groove includes a first section parallel to a plane perpendicular to the optical axis direction and a second section having an inclination with respect to the plane perpendicular to the optical axis direction, and a rotation phase of the operation ring locked from rotating by the click mechanism is located in the vicinity of a rotation phase of the operation ring at which the protrusion is positioned in the second section.

JP2014-098822A discloses a lens barrel including an operation ring that moves a movable lens group, a fixed ring that is fixed to the operation ring, a moving member that is disposed on an outer periphery of the fixed ring or a fixed member that is integrally attached to the fixed ring, a switch member that switches an internal contact by moving the moving member, and a click member that engages with the moving member and the switch member at a first engagement portion and a second engagement portion and that engages with a step portion provided on the fixed ring or the fixed member at a third engagement portion, in which the click member includes a fourth engagement portion that engages with the fixed ring or the fixed member in a direction perpendicular to a moving direction of the moving member.

JP1992-054932A (JP-H04-054932A) discloses a zooming optical system including a main lens that reciprocates along an optical axis and an additional lens that is inserted and detached in an optical path in conjunction with the reciprocation of the main lens, a click member having a click groove consisting of an inclined surface inclined with respect to a moving direction of the main lens, a click lever that has a click roller engaging with the click groove and that is rotatably attached to the main lens, and a positioning unit that includes a pressing unit for pressing the click lever in a direction of the click groove and that stops the main lens from reciprocating at a predetermined position, a drive source that includes a drive pulley for moving the main lens, and a loop mechanism that includes a rope that has an engagement unit at an intermediate portion and that is wound around another intermediate portion with a predetermined frictional force with respect to the drive pulley, and that moves the main lens to reciprocate with a predetermined set force, in which the engagement unit is a guide plate that has a slot opening into which a flange member attached to the main lens is inserted with a play amount in a running direction of the rope in a longitudinal direction of the rope along the running direction, and in which, in a case where a movement amount of the flange member from a reference plane of the slot opening in a case where the guide plate is stopped due to a stop of the drive source is denoted by d and a distance between a reference position of the click groove and a contact point of the click roller with the click groove in a case where the drive source is stopped is denoted by e, a relationship of d < e is established.

### SUMMARY OF THE INVENTION

One embodiment according to the technology of the present disclosure provides a lens device and an imaging apparatus that can be reduced in size in a radial direction as compared with the related art.

A first aspect according to the technology of the present disclosure is a lens device including an optical system, a support member that supports the optical system, a movable member that is disposed along an outer periphery of the support member and that is movably supported with respect to the support member, and an engagement mechanism that engages with the movable member, in which the engagement mechanism is inclined with respect to a direction of an optical axis.

A second aspect according to the technology of the present disclosure is the lens device according to the first aspect, in which the movable member includes a rotation ring that is supported to be rotatable with respect to the support member in a direction around the optical axis.

A third aspect according to the technology of the present disclosure is the lens device according to the second aspect, in which the optical system includes a first optical system, and a second optical system that is disposed on an object side with respect to the first optical system, and the lens device includes an interlocking mechanism that moves the first optical system and the second optical system in the direction of the optical axis in response to rotation of the rotation ring.

A fourth aspect according to the technology of the present disclosure is the lens device according to the third aspect, in which the movable member includes an engaged portion that is engaged with the engagement mechanism at a position at which the first optical system and the second optical system are accommodated in the support member.

A fifth aspect according to the technology of the present disclosure is the lens device according to the fourth aspect, in which the position at which the first optical system and the second optical system are accommodated in the support member is a position at which both the first optical system and the second optical system are accommodated in the support member, and is a position corresponding to a retracted end.

A sixth aspect according to the technology of the present disclosure is the lens device according to any one of the first to fifth aspects, in which the engagement mechanism engages with the movable member along an engagement direction, and the engagement direction is inclined with respect to the direction of the optical axis.

A seventh aspect according to the technology of the present disclosure is the lens device according to any one of the first to sixth aspects, further including: a cover that covers the engagement mechanism, in which the cover includes an inclined surface that is inclined with respect to the direction of the optical axis, and the engagement mechanism is inclined with respect to the direction of the optical axis in accordance with inclination of the inclined surface.

An eighth aspect according to the technology of the present disclosure is the lens device according to the seventh aspect, in which the inclined surface includes a first end part that is located on an object side and a second end part that is located on an image forming side, and is inclined with respect to the direction of the optical axis in such a manner that the first end part is located on an outer side of the lens device in a radial direction with respect to the second end part.

A ninth aspect according to the technology of the present disclosure is the lens device according to the seventh or eighth aspect, in which the cover includes a peripheral wall portion that has an outer peripheral surface and an inner peripheral surface, and the inclined surface includes an outer peripheral inclined surface formed on the outer peripheral surface, and an inner peripheral inclined surface formed on the inner peripheral surface.

A tenth aspect according to the technology of the present disclosure is the lens device according to any one of the first to ninth aspects, in which the engagement mechanism includes an engagement member that engages with the movable member, and a biasing member that biases the engagement member toward a movable member side.

An eleventh aspect according to the technology of the present disclosure is the lens device according to any one of the first to tenth aspects, in which the engagement mechanism includes a third end part that is located on an object side and a fourth end part that is located on an image forming side, and is inclined with respect to the direction of the optical axis in such a manner that the third end part is located on an outer side of the lens device in a radial direction with respect to the fourth end part.

A twelfth aspect according to the technology of the present disclosure is the lens device according to any one of the first to eleventh aspects, further including: a plurality of the engagement mechanisms, in which the plurality of engagement mechanisms are provided at intervals in a direction around the optical axis.

A thirteenth aspect according to the technology of the present disclosure is the lens device according to any one of the first to twelfth aspects, in which the engagement mechanism includes an engagement member that engages with the movable member, the engagement member engages with the movable member along an inclination direction that is inclined with respect to the direction of the optical axis, and the support member includes a first support portion that supports the engagement member to be movable in the inclination direction.

A fourteenth aspect according to the technology of the present disclosure is the lens device according to the thirteenth aspect, in which the engagement member includes a supported portion that extends in the inclination direction, and the first support portion supports the supported portion.

A fifteenth aspect according to the technology of the present disclosure is the lens device according to the fourteenth aspect, in which the first support portion includes a groove portion into which the supported portion is inserted to be movable, the groove portion extending in the inclination direction.

A sixteenth aspect according to the technology of the present disclosure is the lens device according to the fourteenth or fifteenth aspect, in which the engagement mechanism includes a third end part that is located on an object side and a fourth end part that is located on an image forming side and is inclined with respect to the direction of the optical axis in such a manner that the third end part is located on an outer side of the lens device in a radial direction with respect to the fourth end part, and the first support portion includes a pressing portion that presses the supported portion from the outer side of the lens device in the radial direction with respect to the supported portion.

A seventeenth aspect according to the technology of the present disclosure is the lens device according to any one of the fourteenth to sixteenth aspects, in which the first support portion includes a pressing portion that presses the supported portion, the pressing portion extending in the direction of the optical axis.

An eighteenth aspect according to the technology of the present disclosure is the lens device according to the seventeenth aspect, in which the pressing portion includes a line contact portion that is in line contact with the supported portion.

A nineteenth aspect according to the technology of the present disclosure is the lens device according to any one of the fourteenth to eighteenth aspects, in which the engagement member includes an engagement portion that engages with the movable member, the supported portion includes a first supported portion and a second supported portion that are arranged in an intersection direction intersecting the inclination direction, the engagement portion is located between the first supported portion and the second supported portion, and the first support portion includes a first pressing portion and a second pressing portion that press the first supported portion and the second supported portion from an outer side of the lens device in a radial direction with respect to the first supported portion and the second supported portion.

A twentieth aspect according to the technology of the present disclosure is the lens device according to any one of the thirteenth to nineteenth aspects, in which the first support portion includes a sliding surface that slides with the engagement member, the sliding surface extending in the inclination direction.

A twenty-first aspect according to the technology of the present disclosure is the lens device according to any one of the first to twentieth aspects, further including: a first support member as the support member; and a second support member that is located on an image forming side with respect to the first support member, in which the engagement mechanism includes an engagement member that engages with the movable member, and a biasing member that biases the engagement member toward a movable member side, the first support member includes a first support portion that supports the engagement member to be movable in an inclination direction that is inclined with respect to the direction of the optical axis, and the second support member includes a second support portion that supports the biasing member.

A twenty-second aspect according to the technology of the present disclosure is the lens device according to the twenty-first aspect, in which the second support portion includes a support surface that supports an end part of the biasing member on the image forming side, and the support surface is a surface perpendicular to the inclination direction.

A twenty-third aspect according to the technology of the present disclosure is the lens device according to the twenty-first or twenty-second aspect, in which the second support portion includes an accommodation portion that accommodates the biasing member, the accommodation portion includes an opening portion that is open toward an engagement member side, and the opening portion is enlarged in diameter toward the engagement member side.

A twenty-fourth aspect according to the technology of the present disclosure is the lens device according to any one of the twenty-first to twenty-third aspects, in which the biasing member includes a coil spring, and the engagement member includes an insertion portion that is inserted into an inner side of the coil spring to support the coil spring.

A twenty-fifth aspect according to the technology of the present disclosure is the lens device according to any one of the first to twenty-fourth aspects, further including: a supported member that is supported by the support member, in which the engagement mechanism includes a third end part that is located on an object side and a fourth end part that is located on an image forming side, and is inclined with respect to the direction of the optical axis in such a manner that the third end part is located on an outer side of the lens device in a radial direction with respect to the fourth end part, and at least a part of the supported member is within a range between the third end part and the fourth end part in the radial direction of the lens device.

A twenty-sixth aspect according to the technology of the present disclosure is an imaging apparatus including: the lens device according to any one of the first to twenty-fifth aspects; and an imaging apparatus body to which the lens device is attached.

A twenty-seventh aspect according to the technology of the present disclosure is the imaging apparatus according to the twenty-sixth aspect, in which the lens device includes a cover that covers the engagement mechanism, the cover includes an inclined surface that is inclined with respect to the direction of the optical axis, the inclined surface includes a first end part that is located on an object side and a second end part that is located on an image forming side, and is inclined with respect to the direction of the optical axis in such a manner that the first end part is located on an outer side of the lens device in a radial direction with respect to the second end part, the imaging apparatus body includes an operation portion, at least a part of the operation portion is within a range between the first end part and the second end part in the radial direction of the lens device, and the engagement mechanism is inclined with respect to the direction of the optical axis in accordance with inclination of the inclined surface.

### BRIEF DESCRIPTION OF THE DRAWINGS

FIG. 1 is a front view of an imaging apparatus including a lens device according to an embodiment of the technology of the present disclosure.

FIG. 2 is a view of the imaging apparatus as viewed in a direction of an arrow F2-F2 of FIG. 1.

FIG. 3 is a side view of the lens device.

FIG. 4 is a side cross-sectional view of the lens device.

FIG. 5 is a view showing a telephoto end, a wide angle end, and a retracted end of the lens device.

FIG. 6 is an enlarged side cross-sectional view of a periphery of an engagement mechanism in the lens device.

FIG. 7 is a perspective view of a zoom ring.

FIG. 8 is a development view schematically showing a relationship between a guide groove and an engagement portion.

FIG. 9 is a perspective view of the lens device.

FIG. 10 is a perspective view of a periphery of the engagement mechanism in the lens device.

FIG. 11 is a perspective view of a periphery of a first support portion in a fixation frame.

FIG. 12 is a perspective view of an engagement member.

FIG. 13 is a side cross-sectional view schematically showing a relationship between a sliding surface, an arm portion of the engagement member, and a pressing portion.

FIG. 14 is a side cross-sectional view schematically showing a relationship between the engagement member, a biasing member, and an accommodation portion.

FIG. 15 is a side cross-sectional view schematically showing a relationship between filtering, an inner barrel, and the engagement mechanism.

FIG. 16 is a side cross-sectional view schematically showing a relationship between a peripheral wall portion of a rear cover according to a modification example and the engagement mechanism.

### DESCRIPTION OF THE PREFERRED EMBODIMENTS

Hereinafter, an example of a lens device and an imaging apparatus according to an embodiment of the technology of the present disclosure will be described with reference to the accompanying drawings. In the following description, the description may be made over a plurality of drawings.

### Imaging Apparatus 10

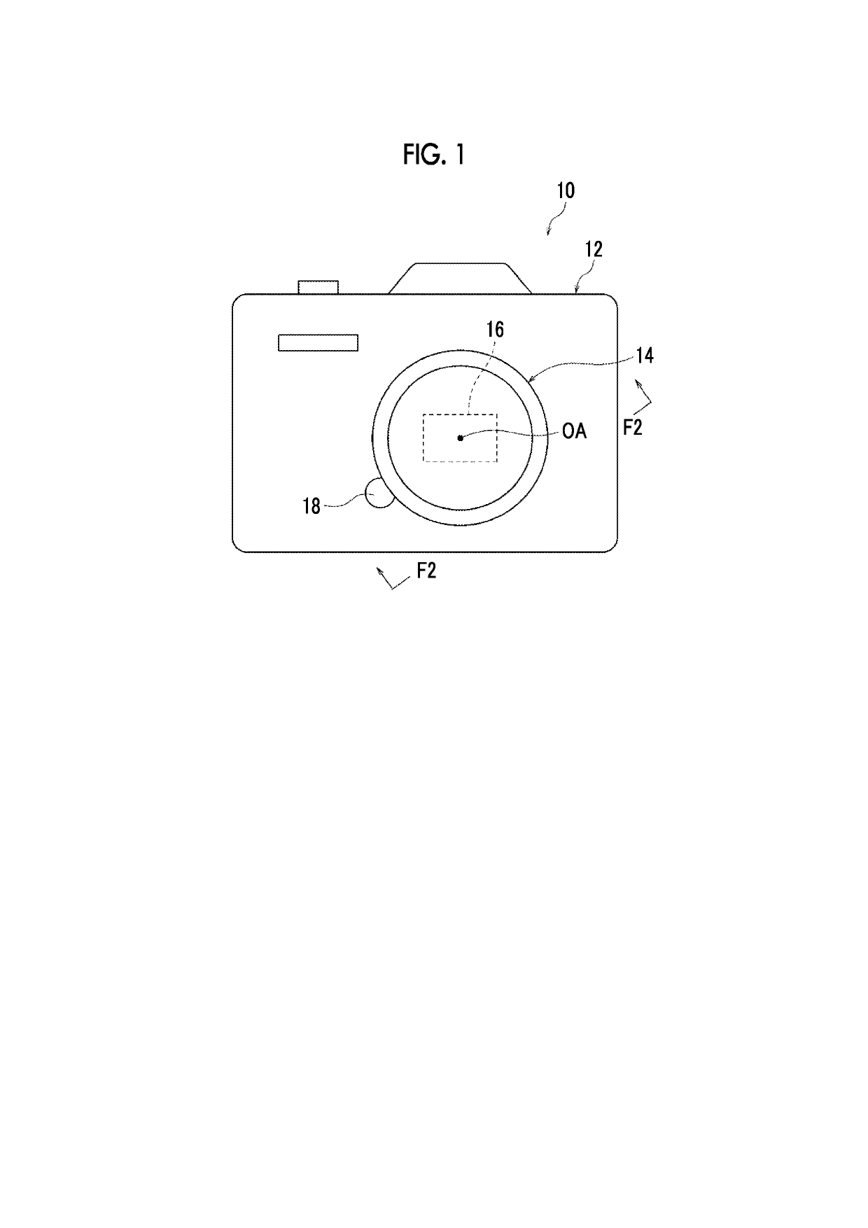

FIG. 1 is a front view of an imaging apparatus 10 including a lens device 14 according to the present embodiment. The imaging apparatus 10 includes an imaging apparatus body 12 and the lens device 14. The imaging apparatus 10 is, for example, a digital still camera, but may be various cameras other than the digital still camera. An image sensor 16 is provided inside the imaging apparatus body 12. The lens device 14 is a device for forming an image of light on a light-receiving surface of the image sensor 16 and is attached to a front surface of the imaging apparatus body 12.

The lens device 14 has an optical axis OA. Hereinafter, a direction of the optical axis OA will be referred to as an “optical axis direction”, and a direction around the optical axis OA will be referred to as a “direction around the optical axis”. In the following description, the optical axis direction refers to a direction parallel to the optical axis OA, and the direction around the optical axis refers to a circumferential direction around the optical axis OA.

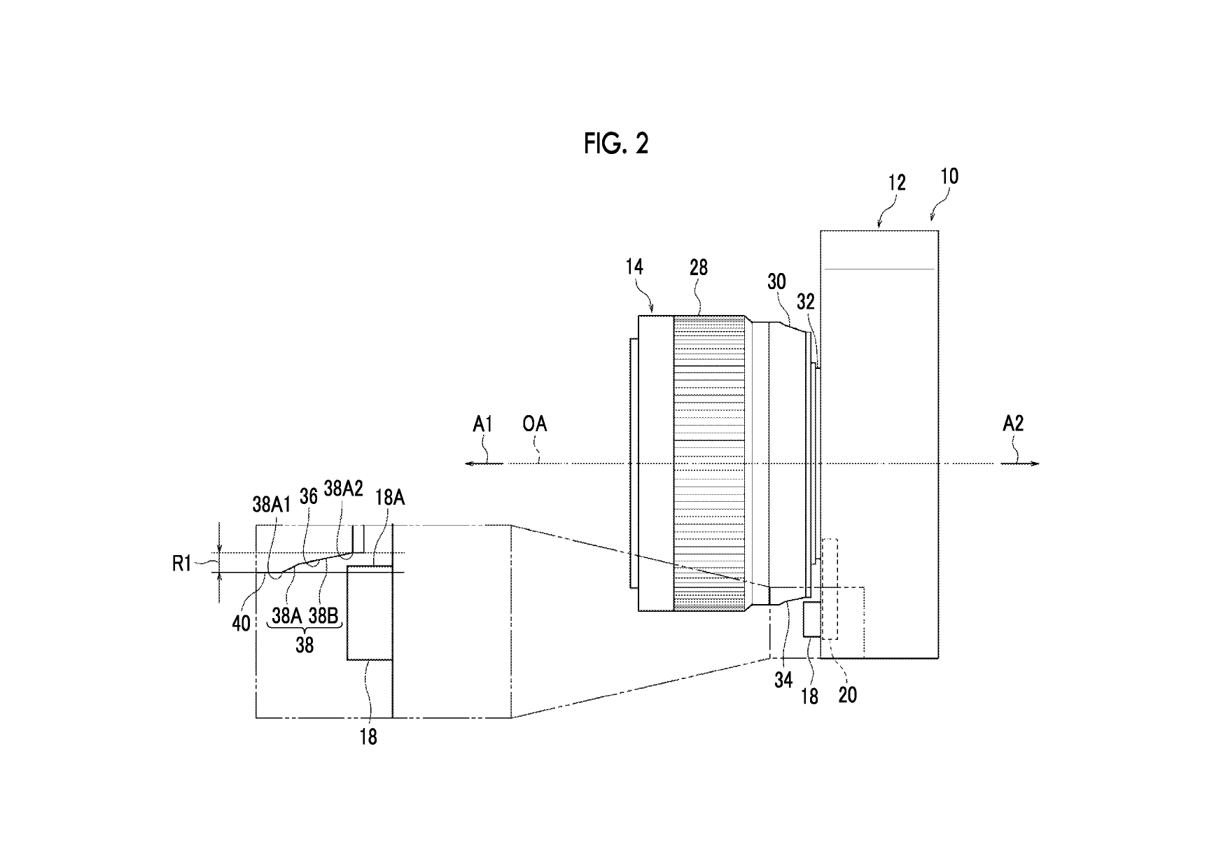

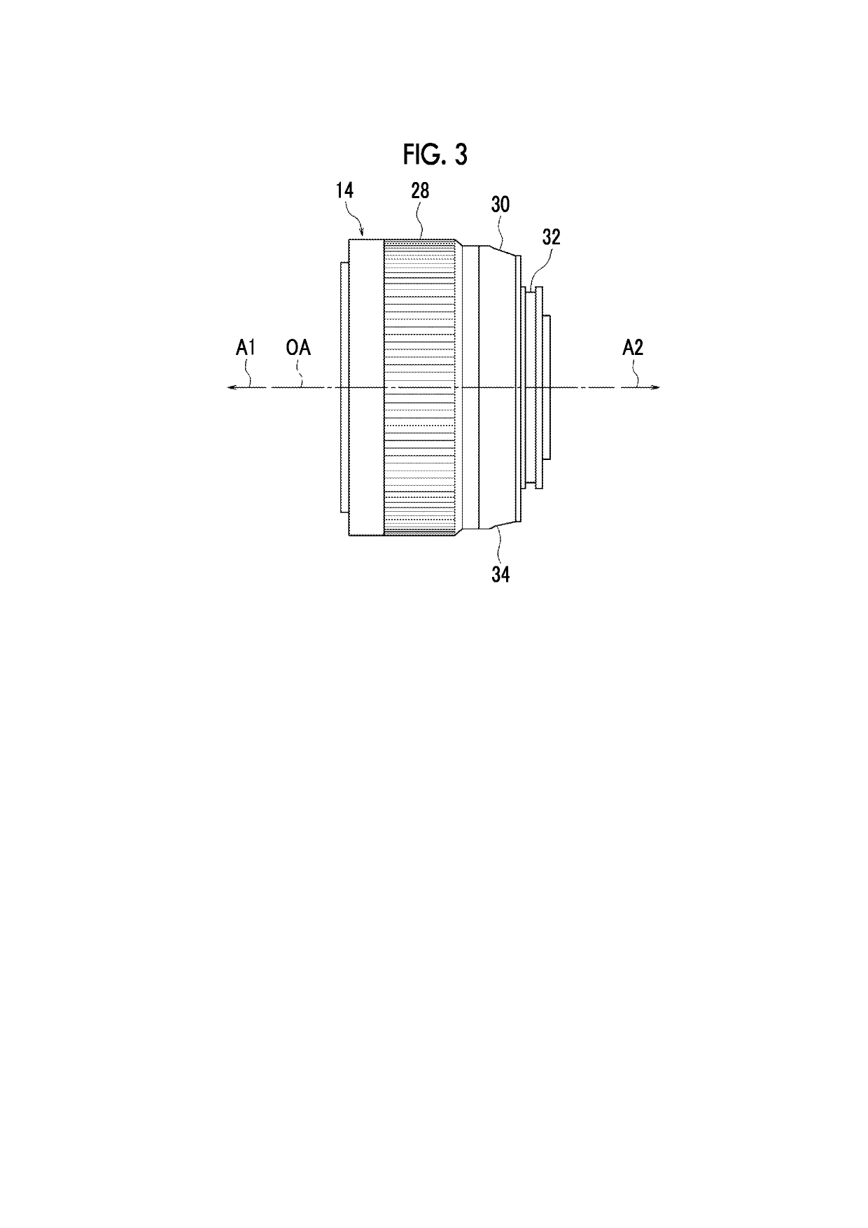

FIG. 2 is a view of the imaging apparatus 10 as viewed in the direction of an arrow F2-F2 of FIG. 1. FIG. 3 is a side view of the lens device 14. An arrow A1 side indicates an object side with respect to the lens device 14, and an arrow A2 side indicates an image forming side with respect to the lens device 14. The configuration of the lens device 14 will be described below, but the lens device 14 includes a zoom ring 28, a rear cover 30, and a lens mount 32. The lens mount 32 is a fixing member that is fixed to a mount portion of the imaging apparatus body 12. The zoom ring 28 is an operation member that is operated by a user to enlarge or reduce an angle of view of the imaging apparatus 10. The rear cover 30 is an external appearance design member that is disposed between the zoom ring 28 and the lens mount 32 in the optical axis direction. The rear cover 30 is an example of a “cover” in the technology of the present disclosure.

The rear cover 30 includes a peripheral wall portion 34. The peripheral wall portion 34 is formed in an annular shape along the direction around the optical axis. The peripheral wall portion 34 is an example of a “peripheral wall portion” according to the technology of the present disclosure. The peripheral wall portion 34 includes an outer peripheral surface 36. The outer peripheral surface 36 includes an outer peripheral inclined surface 38 and an outer peripheral parallel surface 40. The outer peripheral inclined surface 38 is an example of an “inclined surface” according to the technology of the present disclosure. The outer peripheral inclined surface 38 is located on the image forming side of the outer peripheral parallel surface 40.

The outer peripheral inclined surface 38 is inclined with respect to the optical axis direction in a case of being viewed in a direction perpendicular to the optical axis direction. The outer peripheral parallel surface 40 is formed parallel to the optical axis direction. The outer peripheral inclined surface 38 includes a first end part 38A1 that is located on the object side and a second end part 38A2 that is located on the image forming side. The outer peripheral inclined surface 38 is inclined with respect to the optical axis direction in such a manner that the first end part 38A1 is located on an outer side of the lens device 14 in a radial direction with respect to the second end part 38A2.

More specifically, the outer peripheral inclined surface 38 includes a first inclined surface 38A and a second inclined surface 38B. The first inclined surface 38A is located on the object side with respect to the second inclined surface 38B. The first end part 38A1 is an end part of the first inclined surface 38A on the object side, and the second end part 38A2 is an end part of the second inclined surface 38B on the image forming side. An inclination angle of the first inclined surface 38A with respect to the optical axis direction is set to an angle larger than an inclination angle of the second inclined surface 38B with respect to the optical axis direction.

An attachment/detachment button 18 is provided on a front surface of the imaging apparatus body 12, which is a surface on the object side, and an attachment/detachment mechanism 20 is provided inside the imaging apparatus body 12. The attachment/detachment mechanism 20 is a mechanism for attaching and detaching the lens device 14 to and from the imaging apparatus body 12, and the attachment/detachment button 18 is a button for operating the attachment/detachment mechanism 20. The attachment/detachment button 18 is configured by a push button that can be pushed by a finger of a user of the imaging apparatus 10 in the optical axis direction. The attachment/detachment button 18 is a flat columnar member having the optical axis direction as an axial direction, and is formed in a circular shape as viewed in the optical axis direction (see FIG. 1). The attachment/detachment mechanism 20 includes a holding member (not shown) that holds the lens device 14 with respect to the imaging apparatus body 12, and a release member (not shown) that releases a holding state of the holding member with respect to the lens device 14 in a case where the attachment/detachment button 18 is pushed.

A portion 18A of the attachment/detachment button 18 on the outer peripheral inclined surface 38 side is within a range R1 between the first end part 38A1 and the second end part 38A2 of the lens device 14 in the radial direction. As a result, the size of the imaging apparatus 10 in the radial direction of the lens device 14 is reduced, and the external appearance designability of the imaging apparatus 10 as viewed from the front is improved as compared with a case where the attachment/detachment button 18 is disposed at a position outside the range R1. The attachment/detachment button 18 is an example of an “operation portion” according to the technology of the present disclosure.

It should be noted that, here, the attachment/detachment button 18 is described as an example of the operation portion, but an operation member other than the attachment/detachment button 18 may be used. The operation member may be various switches or the like for changing the setting of the imaging apparatus body 12 or the lens device 14. In addition, at least a part of the operation member may be within the range R1.

### Lens Device 14

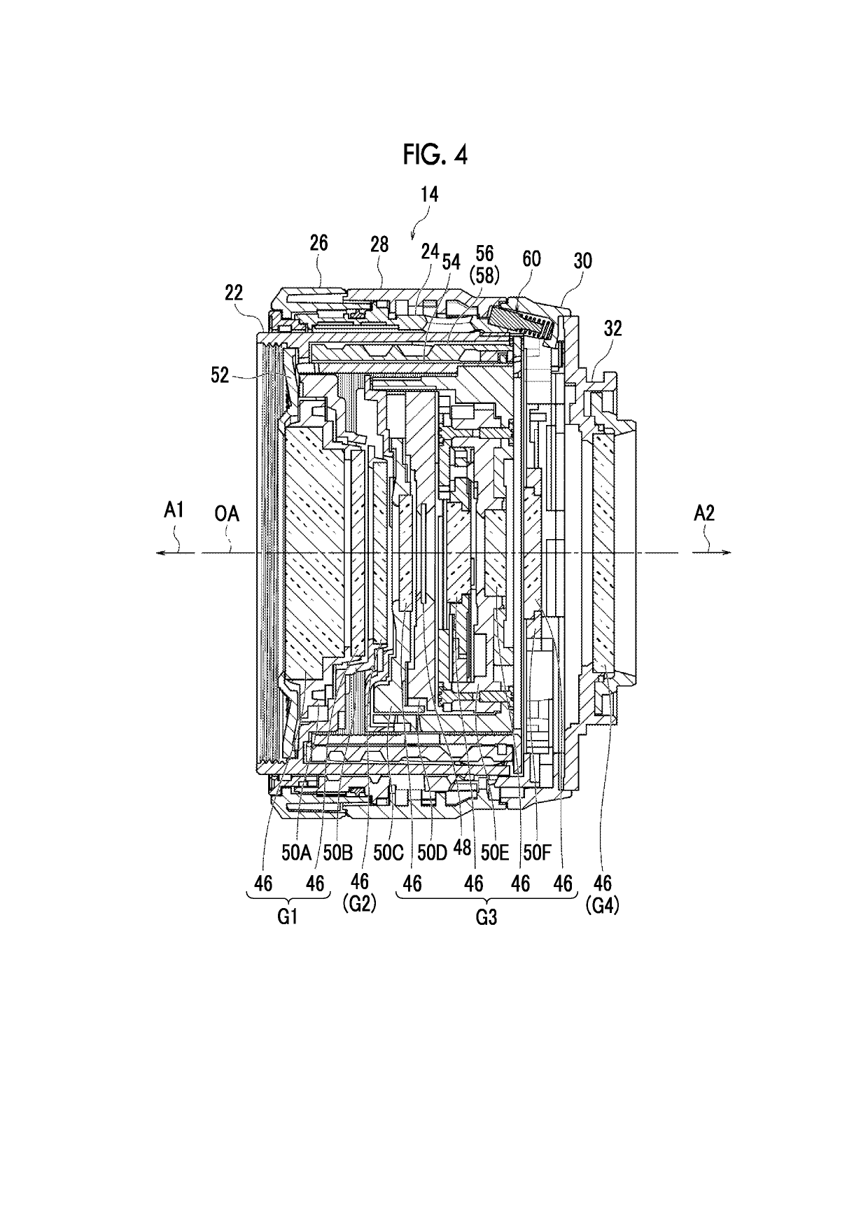

FIG. 4 is a side cross-sectional view of the lens device 14. The lens device 14 includes filtering 22, a fixation frame 24, a focus ring 26, the zoom ring 28, the rear cover 30, and the lens mount 32.

The filtering 22 is provided on an inner side of the fixation frame 24 in the radial direction. The filtering 22 is formed in an annular shape along the direction around the optical axis, and is supported by the fixation frame 24 to be movable in the optical axis direction. The focus ring 26 and the zoom ring 28 are disposed along an outer periphery of the fixation frame 24, and are movably supported by the fixation frame 24. Specifically, the focus ring 26 and the zoom ring 28 are provided on an outer side of the fixation frame 24 in the radial direction. The focus ring 26 is disposed on the object side with respect to the zoom ring 28. The focus ring 26 is formed in an annular shape along the direction around the optical axis, and is supported by the fixation frame 24 to be rotatable in the direction around the optical axis. Similarly, the zoom ring 28 is formed in an annular shape along the direction around the optical axis, and is supported by the fixation frame 24 to be rotatable in the direction around the optical axis.

The lens device 14 includes a plurality of lenses 46 and a stop 48. The plurality of lenses 46 are classified into, for example, a first group G1, a second group G2, a third group G3, and a fourth group G4. The lenses 46 of the first group G1 are, for example, objective lenses, the lenses 46 of the second group G2 are, for example, focus lenses, the lenses 46 of the third group G3 are, for example, zoom lenses, and the lens 46 of the fourth group G4 is, for example, an image forming lens.

The lens device 14 includes a first holding frame 50A, a second holding frame 50B, a third holding frame 50C, a fourth holding frame 50D, a fifth holding frame 50E, and a sixth holding frame 50F. The first holding frame 50A, the second holding frame 50B, the third holding frame 50C, the fourth holding frame 50D, the fifth holding frame 50E, and the sixth holding frame 50F are all formed in an annular shape along the direction around the optical axis. The first holding frame 50A, the second holding frame 50B, the third holding frame 50C, the fourth holding frame 50D, the fifth holding frame 50E, and the sixth holding frame 50F are disposed in order of the first holding frame 50A, the second holding frame 50B, the third holding frame 50C, the fourth holding frame 50D, the fifth holding frame 50E, and the sixth holding frame 50F from the object side toward the image forming side.

The first holding frame 50A and the second holding frame 50B are disposed on the inner side of the filtering 22 in the radial direction, and are connected to the filtering 22 via a connecting member 52. The third holding frame 50C, the fourth holding frame 50D, and the fifth holding frame 50E are disposed on the inner side of an inner barrel 54 (described below) in the radial direction, and are supported by the inner barrel 54 to be movable in the optical axis direction. The sixth holding frame 50F is fixed to an end part of the fixation frame 24 on the image forming side.

The lenses 46 of the first group G1 are held by the first holding frame 50A, and the lenses 46 of the second group G2 are held by the second holding frame 50B. The lens 46 that is located on the object side of the stop 48, among the lenses 46 of the third group G3, is held by the third holding frame 50C, and the stop 48 is held by the fourth holding frame 50D. The lens 46 that is located on an image forming side of the stop 48, among the lenses 46 of the third group G3, is held by the fifth holding frame 50E and the sixth holding frame 50F. The lens 46 of the fourth group G4 is held by the lens mount 32.

The lens 46 of the plurality of lenses 46 that is held by the first holding frame 50A, the second holding frame 50B, the third holding frame 50C, the fourth holding frame 50D, the fifth holding frame 50E, and the sixth holding frame 50F is supported by the fixation frame 24 via the first holding frame 50A, the second holding frame 50B, the third holding frame 50C, the fourth holding frame 50D, the fifth holding frame 50E, and the sixth holding frame 50F. The lens 46 of the plurality of lenses 46 that is held by the lens mount 32 is supported by the fixation frame 24 via the lens mount 32.

The lens device 14 includes the inner barrel 54 and a cam barrel 56. The inner barrel 54 and the cam barrel 56 are both formed in a cylindrical shape. The inner barrel 54 and the cam barrel 56 are disposed concentrically around the optical axis OA. The cam barrel 56 is disposed on the outer side of the inner barrel 54 in the radial direction, and the fixation frame 24 is disposed on the outer side of the cam barrel 56 in the radial direction. The fixation frame 24, the inner barrel 54, and the rear cover 30 are fixing members fixed to the lens mount 32, and the cam barrel 56 is a rotatable member that is supported by the fixation frame 24 and the inner barrel 54 to be rotatable in the direction around the optical axis. The rear cover 30 is located on the image forming side with respect to the fixation frame 24.

The zoom ring 28 is connected to the cam barrel 56 via a connection mechanism (not shown), and, in a case where the zoom ring 28 rotates, the cam barrel 56 rotates. The cam barrel 56 includes a first cam groove (not shown) corresponding to the filtering 22. The filtering 22 includes a first roller (not shown) that is engaged with the first cam groove. In a case where the cam barrel 56 rotates, the first roller moves with respect to the first cam groove of the cam barrel 56, and a rotational force of the cam barrel 56 is converted into a straightening force of the filtering 22 in the optical axis direction, and the first holding frame 50A and the second holding frame 50B move in the optical axis direction together with the filtering 22.

In addition, the cam barrel 56 includes a second cam groove (not shown) corresponding to the third holding frame 50C, the fourth holding frame 50D, and the fifth holding frame 50E. The third holding frame 50C, the fourth holding frame 50D, and the fifth holding frame 50E include a second roller (not shown) that is engaged with the second cam groove. In a case where the cam barrel 56 rotates, the second roller moves with respect to the second cam groove, and a rotational force of the cam barrel 56 is converted into a straightening force of the third holding frame 50C, the fourth holding frame 50D, and the fifth holding frame 50E in the optical axis direction, and the third holding frame 50C, the fourth holding frame 50D, and the fifth holding frame 50E move in the optical axis direction.

The cam barrel 56 including the first cam groove and the second cam groove and the first roller and the second roller provided on the filtering 22, the third holding frame 50C, the fourth holding frame 50D, and the fifth holding frame 50E constitute an interlocking mechanism 58 that moves the filtering 22, the third holding frame 50C, the fourth holding frame 50D, and the fifth holding frame 50E in the optical axis direction in response to the rotation of the zoom ring 28. The interlocking mechanism 58 is an example of an “interlocking mechanism” according to the technology of the present disclosure.

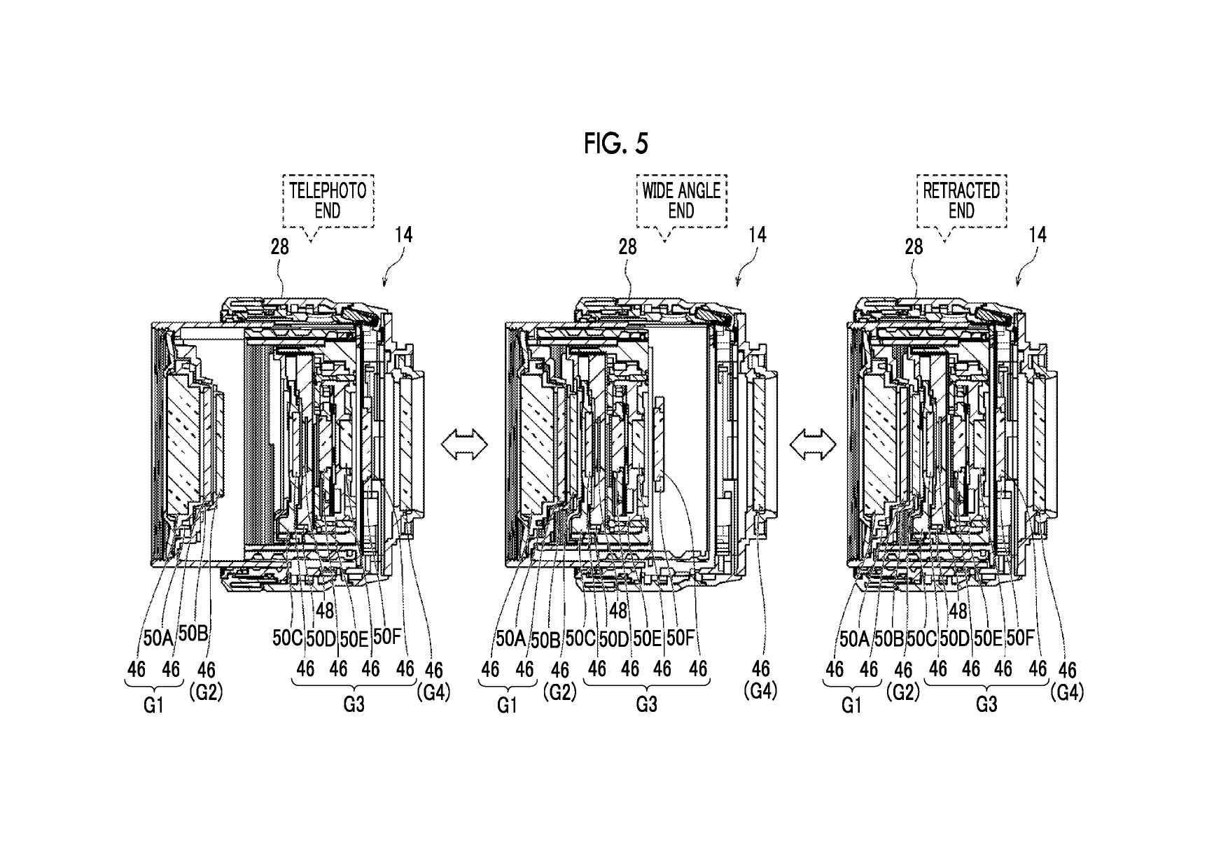

FIG. 5 is a view showing a telephoto end, a wide angle end, and a retracted end of the lens device 14. A position of the lens device 14 changes to the telephoto end, the wide angle end, and the retracted end in response to the rotation of the zoom ring 28. In the telephoto end, the lens 46 and the stop 48 of the plurality of lenses 46 that are held by the third holding frame 50C, the fourth holding frame 50D, and the fifth holding frame 50E move to a position at which the lens 46 is accommodated in the fixation frame 24, and the lens 46 of the plurality of lenses 46 that is held by the first holding frame 50A and the second holding frame 50B moves to a position on the object side with respect to the fixation frame 24. In the wide angle end, the lens 46 of the plurality of lenses 46 that is held by the first holding frame 50A to the fifth holding frame 50E moves to a position on the object side with respect to the fixation frame 24. In the retracted end, the lens 46 of the plurality of lenses 46 that is held by the first holding frame 50A to the fifth holding frame 50E moves to a position at which the lens 46 is accommodated in the fixation frame 24.

The plurality of lenses 46 are examples of an “optical system” according to the technology of the present disclosure. The lens 46 and the stop 48 of the plurality of lenses 46 that are held by the third holding frame 50C, the fourth holding frame 50D, and the fifth holding frame 50E are examples of a “first optical system” according to the technology of the present disclosure. The lens 46 of the plurality of lenses 46 that is held by the first holding frame 50A and the second holding frame 50B is an example of a “second optical system” according to the technology of the present disclosure. The fixation frame 24 is an example of a “support member” according to the technology of the present disclosure. The zoom ring 28 is an example of a “movable member” and a “rotation ring” according to the technology of the present disclosure.

### Engagement Mechanism 60

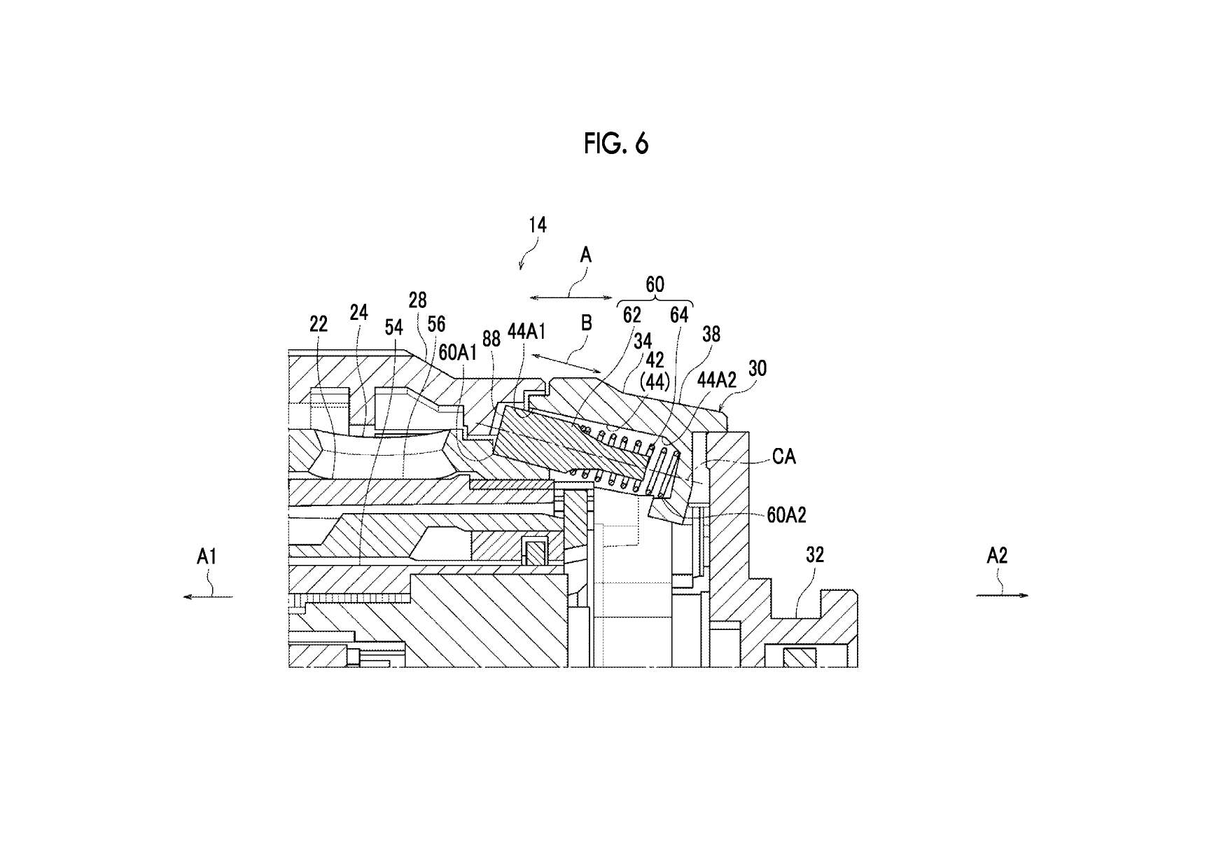

FIG. 6 is an enlarged side cross-sectional view of a periphery of an engagement mechanism 60 in the lens device 14. The lens device 14 includes the engagement mechanism 60. The engagement mechanism 60 is provided at an outer peripheral portion (that is, an outer peripheral side portion) of the lens device 14. The engagement mechanism 60 is an example of an “engagement mechanism” according to the technology of the present disclosure. The engagement mechanism 60 is a mechanism that engages with the zoom ring 28. The engagement mechanism 60 has a central axis CA and engages with the zoom ring 28 along a direction of the central axis CA (that is, an arrow B direction that is a direction parallel to the central axis CA). The engagement mechanism 60 is inclined with respect to the optical axis direction (that is, an arrow A direction that is a direction parallel to the optical axis). Specifically, the direction of the central axis CA of the engagement mechanism 60 is an engagement direction of the engagement mechanism 60, and the engagement direction is inclined with respect to the optical axis direction.

The peripheral wall portion 34 of the rear cover 30 covers the engagement mechanism 60 from the outer side of the lens device 14 in the radial direction. The peripheral wall portion 34 includes an inner peripheral surface 42. An inner peripheral inclined surface 44 is formed on the inner peripheral surface 42. The inner peripheral inclined surface 44 is an example of an “inner peripheral inclined surface” according to the technology of the present disclosure. The inner peripheral inclined surface 44 may form an entire inner peripheral surface 42 or may form a part of the inner peripheral surface 42.

The inner peripheral inclined surface 44 is inclined with respect to the optical axis direction in a case of being viewed in a direction perpendicular to the optical axis direction. The inner peripheral inclined surface 44 includes a first end part 44A1 that is located on the object side and a second end part 44A2 that is located on the image forming side. The inner peripheral inclined surface 44 is inclined with respect to the optical axis direction in such a manner that the first end part 44A1 is located on the outer side of the lens device 14 in the radial direction with respect to the second end part 44A2. Hereinafter, a direction that is the engagement direction of the engagement mechanism 60 and that is inclined with respect to the optical axis direction will be referred to as an “inclination direction”. The arrow B direction indicates the inclination direction.

The engagement mechanism 60 includes an engagement member 62 and a biasing member 64. The engagement member 62 is an example of an “engagement member” according to the technology of the present disclosure. The biasing member 64 is an example of a “biasing member” according to the technology of the present disclosure. The engagement member 62 is a member that engages with the zoom ring 28. The engagement member 62 includes an engagement portion 88 that engages with the zoom ring 28. The biasing member 64 is a member that biases the engagement member 62 toward the zoom ring 28 side. The biasing member 64 is configured by, for example, a coil spring, but may be various elastic members other than the coil spring. The engagement member 62 and the biasing member 64 are disposed on the central axis CA of the engagement mechanism 60. The engagement member 62 engages with the zoom ring 28 along the arrow B direction that is the inclination direction. The biasing member 64 biases the engagement member 62 toward the zoom ring 28 side along the arrow B direction that is the inclination direction.

The engagement mechanism 60 includes a third end part 60A1 that is located on the object side and a fourth end part 60A2 that is located on the image forming side. The engagement mechanism 60 is inclined with respect to the optical axis direction in accordance with the inclinations of the outer peripheral inclined surface 38 and the inner peripheral inclined surface 44 of the rear cover 30. Specifically, the engagement mechanism 60 is inclined with respect to the optical axis direction in such a manner that the third end part 60A1 is located on the outer side of the lens device 14 in the radial direction with respect to the fourth end part 60A2. The third end part 60A1 is an end part of the engagement member 62 on the inner side of the lens device 14 in the radial direction and on the object side, and the fourth end part 60A2 is an end part of the biasing member 64 on the inner side of the lens device 14 in the radial direction and on the image forming side.

The lens device 14 includes a plurality of engagement mechanisms 60. The number of the engagement mechanisms 60 may be two or more. The plurality of engagement mechanisms 60 are provided at intervals in the direction around the optical axis. The plurality of engagement mechanisms 60 are provided at equal intervals in the direction around the optical axis as an example, but may be provided at unequal intervals. For example, the lens device 14 may include three engagement mechanisms 60, and the three engagement mechanisms 60 may be provided at equal intervals in the direction around the optical axis.

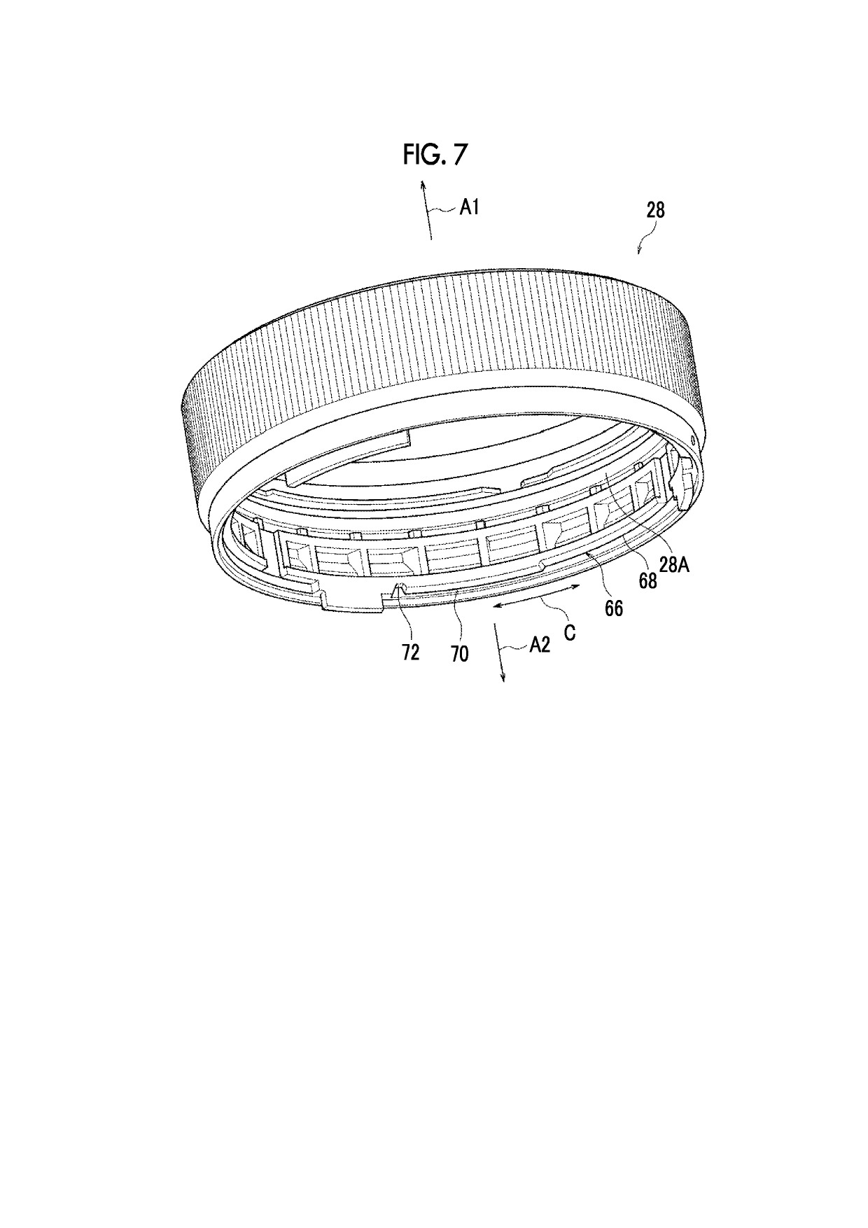

FIG. 7 is a perspective view of the zoom ring 28. A guide groove 66 is formed on an inner peripheral surface 28A of the zoom ring 28. The guide groove 66 extends in a circumferential direction (that is, a direction around the optical axis) of the zoom ring 28. The guide groove 66 extends from a position corresponding to the telephoto end to a position corresponding to the retracted end. The guide groove 66 includes a recessed portion 68, a protruding portion 70, and an engaged portion 72. The recessed portion 68 is formed to be recessed on the object side. The protruding portion 70 is formed to be protruded on the image forming side. The protruding portion 70 is located between the recessed portion 68 and the engaged portion 72. The engaged portion 72 is formed to be recessed on the object side. The engaged portion 72 is an example of an “engaged portion” according to the technology of the present disclosure.

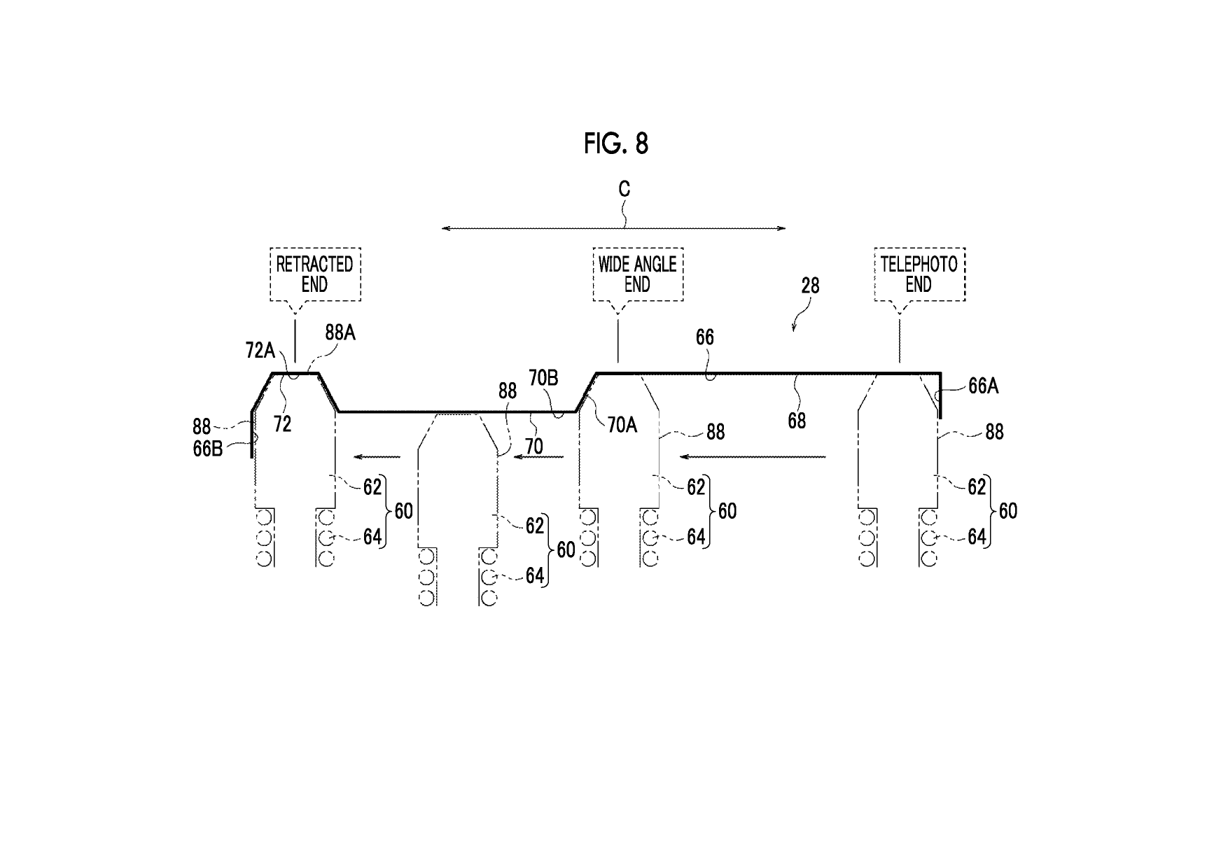

FIG. 8 is a development view schematically showing a relationship between the guide groove 66 and the engagement portion 88. The arrow C direction indicates the direction around the optical axis. The recessed portion 68 extends from a position corresponding to the telephoto end to a position corresponding to the wide angle end. The protruding portion 70 is formed between a position corresponding to the wide angle end and a position corresponding to the retracted end. The engaged portion 72 is formed at a position corresponding to the retracted end. In a case where the zoom ring 28 is rotated, the engagement portion 88 relatively moves with respect to the guide groove 66 in the circumferential direction of the zoom ring 28.

The guide groove 66 includes a first side surface 66A formed at a position corresponding to the telephoto end and a second side surface 66B formed at a position corresponding to the retracted end. In the telephoto end, the engagement portion 88 abuts against the first side surface 66A, and the rotation of the zoom ring 28 is restricted. Between the telephoto end and the wide angle end, the engagement portion 88 moves in a section of the recessed portion 68. Between the telephoto end and the wide angle end, a compression amount of the biasing member 64 is smaller than that in a case where the engagement portion 88 moves in a section of the protruding portion 70. As a result, a frictional force acting between the engagement member 62 and the zoom ring 28 is reduced, and an operation force required for rotating the zoom ring 28 is reduced.

In the wide angle end, the engagement portion 88 abuts against a side surface 70A of the protruding portion 70 (in other words, a side surface of the recessed portion 68), and the rotation of the zoom ring 28 is temporarily restricted. The side surface 70A of the protruding portion 70 is formed by an inclined surface that is inclined toward the engaged portion 72 side. In a case where the zoom ring 28 is rotated from a position corresponding to the wide angle end to a position corresponding to the retracted end, the engagement portion 88 overcomes the side surface 70A of the protruding portion 70 against the biasing force of the biasing member 64 and abuts against a distal end surface 70B of the protruding portion 70. Between the wide angle end and the retracted end, the engagement portion 88 moves in a section of the protruding portion 70. Between the wide angle end and the retracted end, the compression amount of the biasing member 64 is larger than that in a case where the engagement portion 88 moves in a section of the recessed portion 68. As a result, the frictional force acting between the engagement member 62 and the zoom ring 28 is increased, and the operation force required for rotating the zoom ring 28 is temporarily increased.

In a case where the engagement portion 88 reaches a position corresponding to the retracted end, the engagement portion 88 is inserted into the engaged portion 72 by the biasing force of the biasing member 64, and the distal end surface 70B of the engagement portion 88 abuts against a bottom surface 72A of the engaged portion 72 with a force. As a result, a click feeling is generated in the zoom ring 28. Then, the engagement portion 88 is engaged with the engaged portion 72. In addition, in a case where the engagement portion 88 reaches the position corresponding to the retracted end, the engagement portion 88 abuts against the second side surface 66B, and the rotation of the zoom ring 28 is restricted.

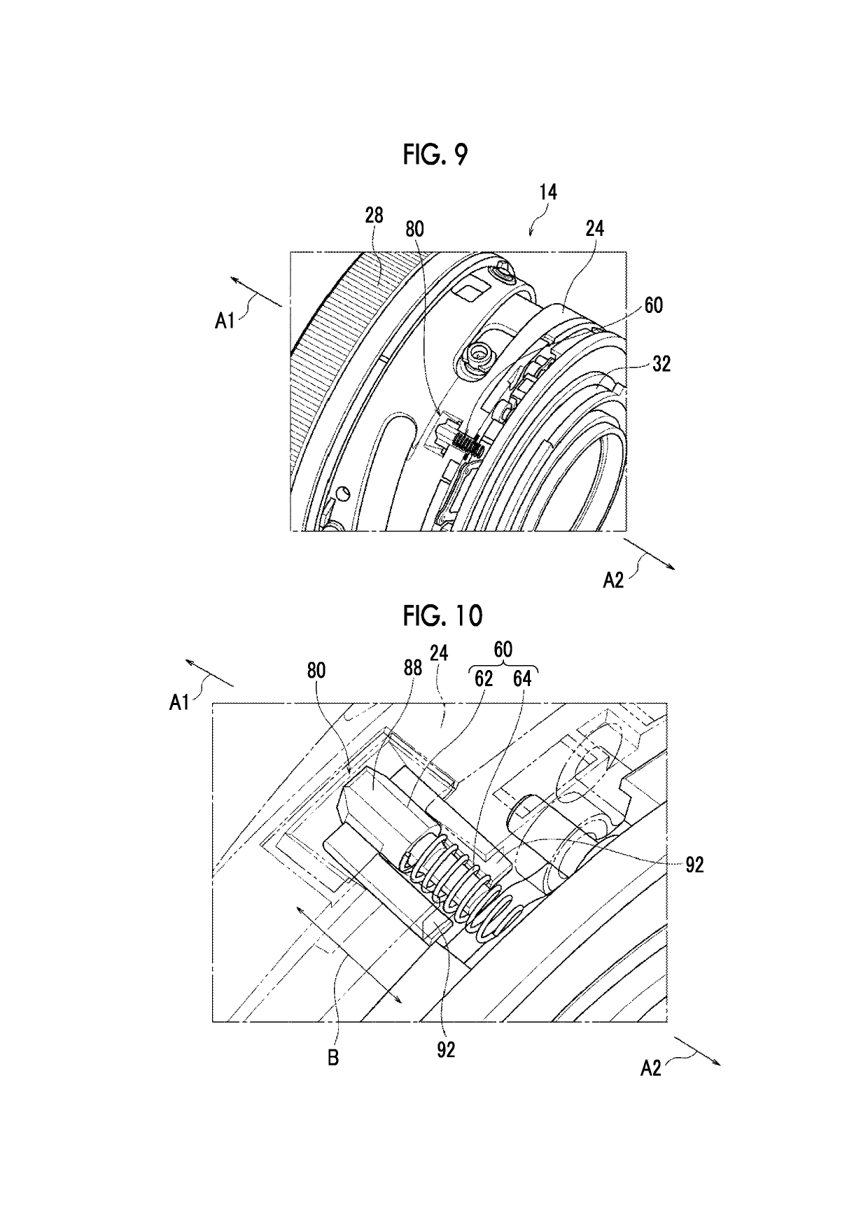

FIG. 9 is a perspective view of the lens device 14. In FIG. 9, the rear cover 30 is not shown. FIG. 10 is a perspective view of a periphery of the engagement mechanism 60 in the lens device 14. In FIG. 10, a part of the fixation frame 24 is indicated by an imaginary line. The fixation frame 24 includes a first support portion 80. The first support portion 80 is an example of a “first support portion” according to the technology of the present disclosure. The first support portion 80 supports the engagement member 62 to be movable along the arrow B direction that is the inclination direction. More specifically, the first support portion 80 supports the engagement portion 88 and a pair of arm portions 92 (described below) to be movable.

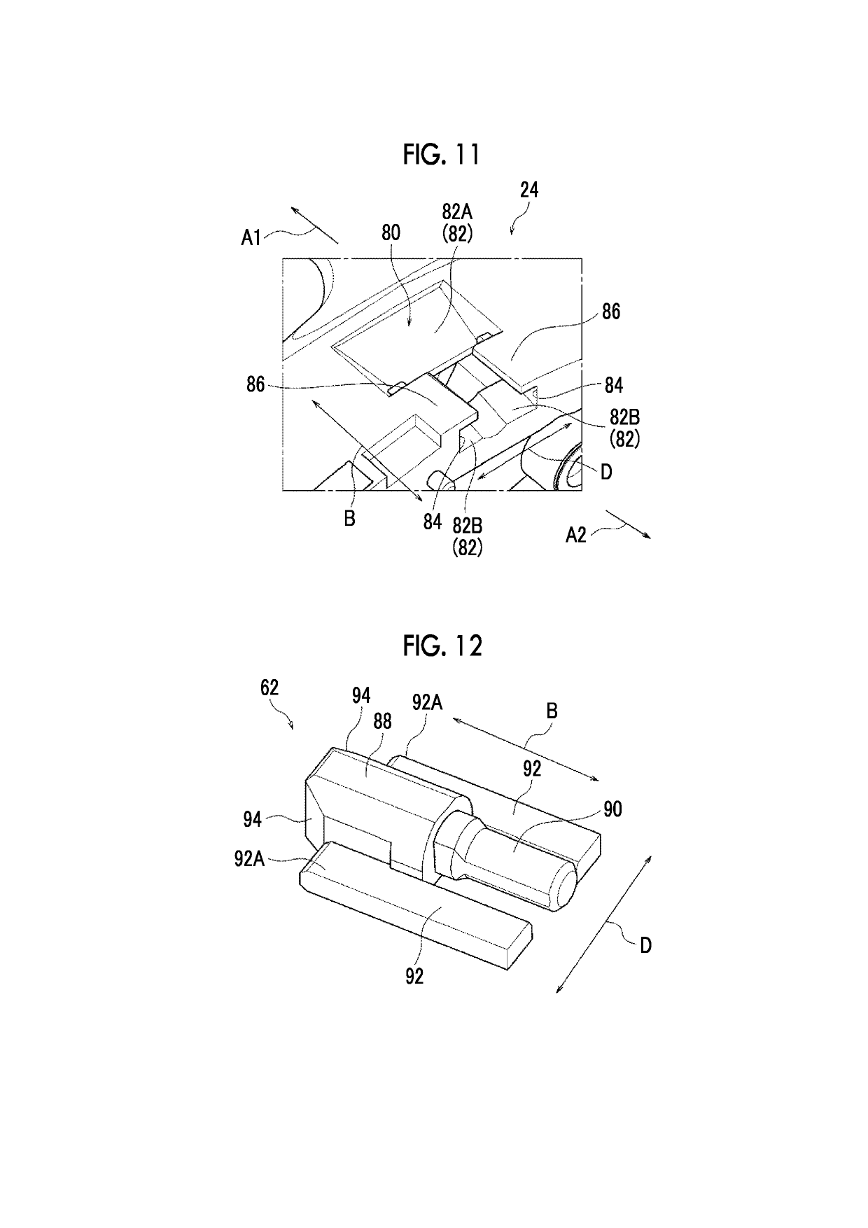

FIG. 11 is a perspective view of a periphery of the first support portion 80 in the fixation frame 24. The first support portion 80 includes a sliding surface 82. The sliding surface 82 is a surface that slides with the engagement member 62. The sliding surface 82 is an example of a “sliding surface” according to the technology of the present disclosure. The sliding surface 82 includes a first sliding surface 82A and a pair of second sliding surfaces 82B. The first sliding surface 82A and the pair of second sliding surfaces 82B are inclined with respect to the optical axis direction and extend in the arrow B direction that is the inclination direction. The first sliding surface 82A and the pair of second sliding surfaces 82B are surfaces facing the outer side of the lens device 14 in the radial direction. The engagement mechanism 60 is inclined with respect to the optical axis direction by the engagement member 62 being supported by the first sliding surface 82A and the pair of second sliding surfaces 82B from the inner side of the lens device 14 in the radial direction. That is, the first sliding surface 82A and the pair of second sliding surfaces 82B are inclined surfaces that define an inclination angle of the engagement mechanism 60.

In addition, the first support portion 80 includes a pair of groove portions 84 that extend in the arrow B direction that is the inclination direction. The groove portions 84 are examples of a “groove portion” according to the technology of the present disclosure. The pair of groove portions 84 are formed side by side in an arrow D direction that is a direction intersecting the arrow B direction (specifically, a direction perpendicular to the arrow B direction). Each groove portion 84 is open on both sides in the arrow B direction. In addition, each groove portion 84 is open to face each other in the arrow D direction that is a tangent direction of the zoom ring 28. The arm portion 92 is inserted into each groove portion 84 to be movable in the arrow B direction that is the inclination direction.

In addition, the first support portion 80 includes a pair of pressing portions 86. Each pressing portion 86 is formed in a wall shape that covers the groove portion 84 from the outer side of the lens device 14 in the radial direction. Each pressing portion 86 extends along the optical axis direction. Each pressing portion 86 is a portion that presses the arm portion 92 inserted into the groove portion 84 from the outer side of the lens device 14 in the radial direction. The pressing portions 86 are examples of a “pressing portion” according to the technology of the present disclosure. The pair of pressing portions 86 are examples of a “first pressing portion” and a “second pressing portion” according to the technology of the present disclosure.

FIG. 12 is a perspective view of the engagement member 62. The engagement member 62 includes the engagement portion 88, an insertion portion 90, and the pair of arm portions 92. The insertion portion 90 is an example of an “insertion portion” according to the technology of the present disclosure. The pair of arm portions 92 are examples of a “supported portion”, a “first supported portion”, and a “second supported portion” according to the technology of the present disclosure. The arrow B direction and the arrow D direction shown in FIG. 10 indicate directions in a state where the engagement member 62 is assembled to the lens device 14. The engagement portion 88 is formed in a pin shape and extends in the arrow B direction that is the inclination direction. The end part of the engagement member 62 on the object side is a distal end part of the engagement portion 88. A pair of inclined surfaces 94 is formed on the distal end part of the engagement portion 88. The pair of inclined surfaces 94 are formed side by side in the arrow D direction. The distal end part of the engagement portion 88 is formed in a pointed shape by the pair of inclined surfaces 94. The distal end part of the engagement portion 88 engages with the zoom ring 28.

The insertion portion 90 extends from a rear end part of the engagement portion 88 to a side opposite to the distal end part of the engagement portion 88. The insertion portion 90 supports the biasing member 64 by being inserted into an inner side of the biasing member 64 that is a coil spring. The pair of arm portions 92 are arranged in the arrow D direction that is a direction intersecting the arrow B direction. The arrow D direction is, more specifically, a direction perpendicular to the arrow B direction. Each arm portion 92 extends in the arrow B direction that is the inclination direction. An end part 92A of each arm portion 92 on the object side is a base end part of each arm portion 92. The base end part of each arm portion 92 is connected to the engagement portion 88. The engagement portion 88 is located between the pair of arm portions 92.

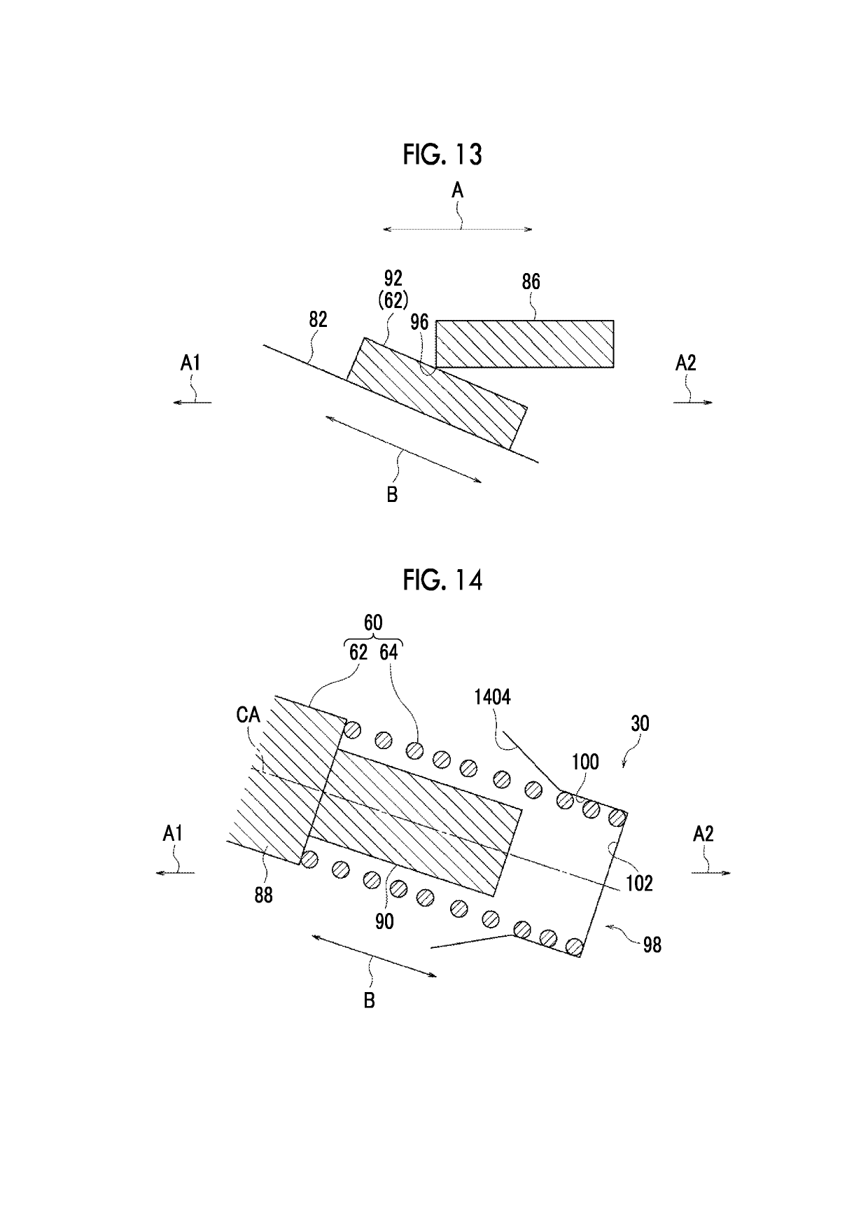

FIG. 13 is a side cross-sectional view schematically showing a relationship between the sliding surface 82, the arm portions 92 of the engagement member 62, and the pressing portions 86. In a state where the arm portions 92 are supported by the sliding surface 82, the arm portions 92 extend in the arrow B direction that is the inclination direction, whereas the pressing portions 86 extend along the arrow A direction that is the optical axis direction. As a result, an end part of the pressing portion 86 on the object side is formed as a line contact portion 96 that is in line contact with the arm portions 92. More specifically, the line contact portion 96 is in point contact with the arm portions 92 in a case of being viewed in a direction perpendicular to the arrow B direction, and is in line contact with the arm portions 92 along a direction perpendicular to the arrow B direction in a case of being viewed in the arrow B direction. The line contact portion 96 is an example of a “line contact portion” according to the technology of the present disclosure. The pressing portion 86 is located on the outer side of the lens device 14 in the radial direction with respect to the arm portions 92. The pressing portion 86 (more specifically, the line contact portion 96) presses the arm portions 92 from the outer side of the lens device 14 in the radial direction with respect to the arm portions 92.

FIG. 14 is a side cross-sectional view schematically showing a relationship between the engagement member 62, the biasing member 64, and an accommodation portion 100. The rear cover 30 includes a second support portion 98 that supports the biasing member 64. The second support portion 98 is an example of a “second support portion” according to the technology of the present disclosure. The second support portion 98 supports a portion of the biasing member 64 on the image forming side. The second support portion 98 includes the accommodation portion 100 that accommodates the portion of the biasing member 64 on the image forming side. The accommodation portion 100 is an example of an “accommodation portion” according to the technology of the present disclosure. The accommodation portion 100 is open in the arrow B direction that is the inclination direction and is formed in a recessed shape with the arrow B direction as a central axis. The accommodation portion 100 is formed in a circular shape in a case of being viewed in the arrow B direction. A bottom surface of the second support portion 98 is formed as a support surface 102 that supports an end part of the biasing member 64 on the image forming side. The support surface 102 is an example of a “support surface” according to the technology of the present disclosure. The support surface 102 is a surface perpendicular to the arrow B direction that is the inclination direction.

The accommodation portion 100 includes an opening portion 104. The opening portion 104 is an example of an “opening portion” according to the technique of the present disclosure. The opening portion 104 is open to the engagement member 62 side (that is, the object side) along the arrow B direction that is the inclination direction. The opening portion 104 has a gradient that is enlarged in diameter toward the engagement member 62 side.

It should be noted that the lens device 14 is assembled, for example, as follows. That is, the lens device 14 is assembled in order from a member located on the object side among a plurality of constituent members constituting the lens device 14 in a state where the object side is directed downward in the vertical direction.

In addition, the engagement mechanism 60 is assembled between the fixation frame 24 and the rear cover 30, for example, as follows. That is, in a stage before the rear cover 30 is assembled to the fixation frame 24, the pair of arm portions 92 are inserted into the pair of groove portions 84 formed in the fixation frame 24, and the engagement member 62 is assembled to the fixation frame 24. Subsequently, the biasing member 64 is assembled to the insertion portion 90 of the engagement member 62, and the biasing member 64 is supported by the insertion portion 90. Subsequently, the rear cover 30 is assembled to the fixation frame 24 from the image forming side of the fixation frame 24.

In a step of assembling the rear cover 30 to the fixation frame 24, the portion of the biasing member 64 on the image forming side is accommodated in the accommodation portion 100. In addition, in a process of accommodating the portion of the biasing member 64 on the image forming side in the accommodation portion 100, the end part of the biasing member 64 on the image forming side is guided into the opening portion 104 having the gradient, so that the portion of the biasing member 64 on the image forming side is accommodated in the accommodation portion 100. Then, the rear cover 30 is fixed to the fixation frame 24, and the engagement mechanism 60 is assembled between the fixation frame 24 and the rear cover 30. The fixation frame 24 is an example of a “first support member” according to the technology of the present disclosure. The rear cover 30 is an example of a “second support member” according to the technology of the present disclosure.

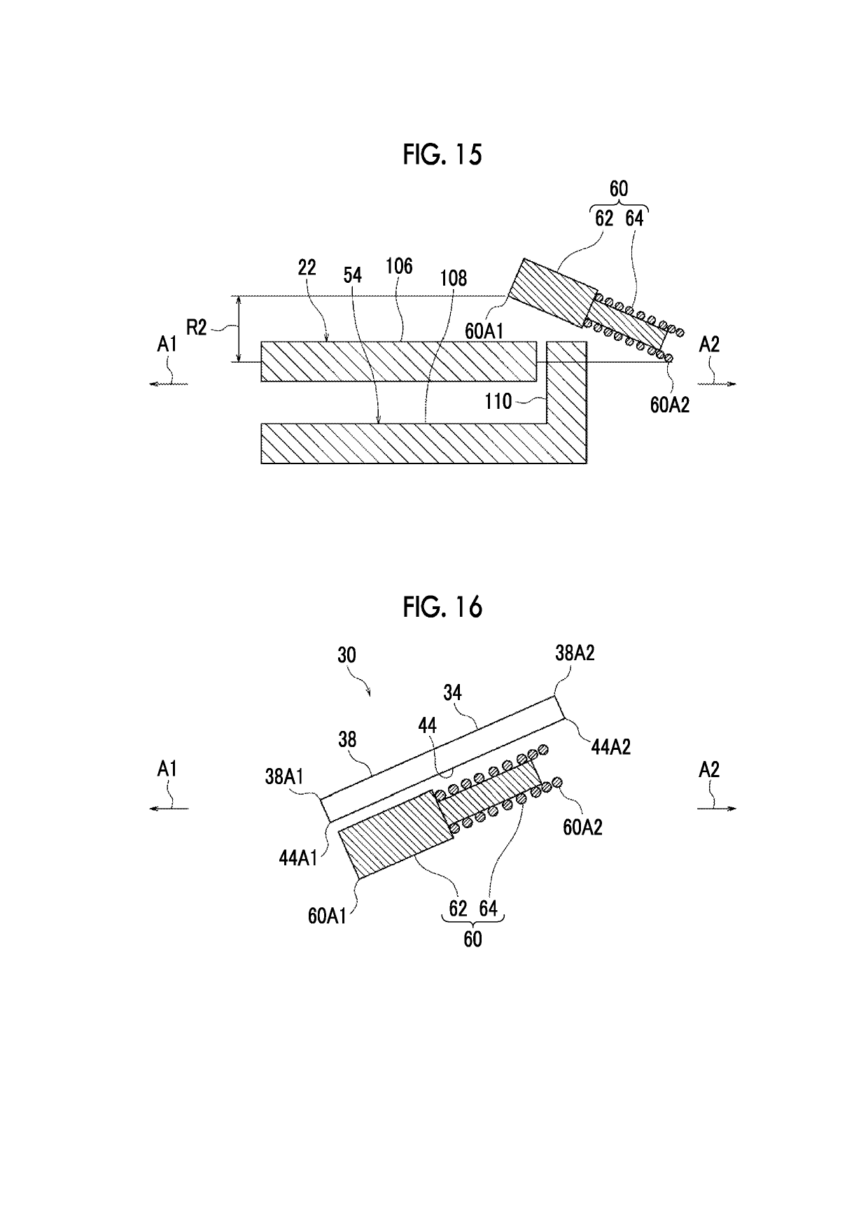

FIG. 15 is a side cross-sectional view schematically showing a relationship between the filtering 22, the inner barrel 54, and the engagement mechanism 60. As described above, the engagement mechanism 60 is inclined with respect to the optical axis direction in such a manner that the third end part 60A1 is located on the outer side of the lens device 14 in the radial direction with respect to the fourth end part 60A2. The third end part 60A1 is an end part of the engagement member 62 on the inner side of the lens device 14 in the radial direction and on the object side, and the fourth end part 60A2 is an end part of the biasing member 64 on the inner side of the lens device 14 in the radial direction and on the image forming side. The filtering 22 includes an annular portion 106 that is formed in an annular shape along the direction around the optical axis.

The inner barrel 54 includes a tubular portion 108 and a flange portion 110. The tubular portion 108 is formed in a tubular shape along the direction around the optical axis. The flange portion 110 is formed at an end part of the tubular portion 108 on the image forming side, and is expanded to the outer side of the lens device 14 in the radial direction with respect to the tubular portion 108. The flange portion 110 is formed in a plate shape having the optical axis direction as a plate thickness direction. The flange portion 110 is formed in an annular shape along the direction around the optical axis. The filtering 22 and the inner barrel 54 are examples of a “supported member” according to the technology of the present disclosure.

A part of the filtering 22 is within a range R2 between the third end part 60A1 and the fourth end part 60A2 of the lens device 14 in the radial direction. Specifically, a part of the annular portion 106 on the outer side in the radial direction is within the range R2. Similarly, a part of the inner barrel 54 is within the range R2 between the third end part 60A1 and the fourth end part 60A2 of the lens device 14 in the radial direction. Specifically, a part of the flange portion 110 on the outer side in the radial direction is within the range R2.

Next, the effects of the present embodiment will be described.

As described above in detail, in the lens device 14 according to the present embodiment, the engagement mechanism 60 is inclined with respect to the optical axis direction (see FIG. 6). Therefore, for example, the lens device 14 can be reduced in size in the radial direction as compared with a case where the engagement mechanism 60 is provided along the optical axis direction. That is, by inclining the engagement mechanism 60 with respect to the optical axis direction, a part of the filtering 22 and a part of the inner barrel 54 can be within the range R2 between the third end part 60A1 and the fourth end part 60A2 of the lens device 14 in the radial direction (see FIG. 15). As a result, for example, by inclining the engagement mechanism 60 with respect to the optical axis direction, the lens device 14 can be reduced in size in the radial direction as compared with a case where the part of the filtering 22 and the part of the inner barrel 54 are located on the inner side of the lens device 14 in the radial direction with respect to the engagement mechanism 60.

In addition, by accommodating the part of the filtering 22 and the part of the inner barrel 54 in the range R2 between the third end part 60A1 and the fourth end part 60A2 of the lens device 14 in the radial direction, the lens device 14 can be reduced in size in the axial direction as compared with a case where the part of the filtering 22 and the part of the inner barrel 54 are arranged in the axial direction of the lens device 14 with respect to the engagement mechanism 60.

In addition, in the imaging apparatus 10 including the lens device 14 according to the present embodiment, the peripheral wall portion 34 of the rear cover 30 includes the outer peripheral inclined surface 38, and the outer peripheral inclined surface 38 is inclined with respect to the optical axis direction in such a manner that the first end part 38A1 is located on the outer side of the lens device 14 in the radial direction with respect to the second end part 38A2. Then, the portion 18A of the attachment/detachment button 18 on the outer peripheral inclined surface 38 side is within the range R1 between the first end part 38A1 and the second end part 38A2 of the lens device 14 in the radial direction (see FIG. 2). As a result, the size of the imaging apparatus 10 in the radial direction of the lens device 14 can be reduced, and the external appearance designability of the imaging apparatus 10 as viewed from the front can be improved as compared with a case where the attachment/detachment button 18 is disposed at a position outside the range R1.

In addition, in the lens device 14 according to the present embodiment, in a case where the zoom ring 28 is rotated and the position of the lens device 14 is retracted to the retracted end, the engagement mechanism 60 is engaged with the zoom ring 28 to generate a click feeling (see FIG. 8). As a result, it is possible to notify the user that the position of the lens device 14 is retracted to the retracted end, so that the operability of the lens device 14 can be improved.

In addition, in the lens device 14 according to the present embodiment, the plurality of engagement mechanisms 60 are provided at intervals in the direction around the optical axis. As a result, each engagement mechanism 60 can be reduced in size as compared with a case where the lens device 14 includes one engagement mechanism 60. That is, by using the plurality of engagement mechanisms 60, a force required to obtain the click feeling is dispersed to each engagement mechanism 60, so that the biasing member 64 of each engagement mechanism 60 can be reduced in size.

In addition, the engagement member 62 includes the arm portions 92 that extend in the inclination direction, and the first support portion 80 formed in the fixation frame 24 includes the groove portions 84 that extend in the inclination direction and into which the arm portions 92 are inserted to be movable (see FIGS. 10 to 12). As a result, the engagement member 62 can be supported to be movable in the inclination direction while suppressing the engagement member 62 from floating due to a reaction force received from the zoom ring 28 as compared with a case where the groove portions 84 are not provided.

In addition, the first support portion 80 includes the pressing portions 86 that press the arm portions 92 from the outer side of the lens device 14 in the radial direction with respect to the arm portions 92 (see FIGS. 10 to 13). As a result, the engagement member 62 can be suppressed from floating due to the reaction force received from the zoom ring 28 as compared with a case where the pressing portions 86 are not provided.

In addition, the pressing portions 86 include the line contact portions 96 that is in line contact with the arm portions 92 (see FIG. 13). As a result, the frictional force between the pressing portions 86 and the arm portions 92 can be reduced as compared with a case where the pressing portions 86 are in surface contact with the arm portions 92, so that the movement of the engagement member 62 can be made smooth.

In addition, the engagement member 62 includes the pair of arm portions 92, and the engagement portion 88 is located between the pair of arm portions 92 (see FIG. 12). The first support portion 80 includes the pair of pressing portions 86 that press the pair of arm portions 92 (see FIG. 11). As a result, the engagement member 62 can be supported in a balanced manner as compared with a case where the engagement member 62 includes the arm portions 92 on only one side, so that the engagement member 62 can be suppressed from floating due to the reaction force received from the zoom ring 28.

In addition, the second support portion 98 includes the accommodation portion 100 that accommodates the biasing member 64, and the accommodation portion 100 includes the opening portion 104 that is open toward the engagement member 62 side. The opening portion 104 has a gradient that is enlarged in diameter toward the engagement member 62 side (see FIG. 14). Therefore, in a process of accommodating the portion of the biasing member 64 on the image forming side in the accommodation portion 100, the portion of the biasing member 64 on the image forming side can be accommodated in the accommodation portion 100 while the end part of the biasing member 64 on the image forming side is guided into the opening portion 104. As a result, workability in a case of assembling the rear cover 30 to the fixation frame 24 can be improved as compared with a case where the opening portion 104 does not have the gradient.

In addition, the engagement member 62 includes the insertion portion 90 that supports the biasing member 64 by being inserted into the inner side of the biasing member 64 that is a coil spring (see FIGS. 12 and 14). As a result, the engagement member 62 can be reduced in size, and thus the engagement mechanism 60 can be reduced in size as compared with a case where the engagement member 62 includes a hole that accommodates the biasing member 64.

Next, modification examples of the present embodiment will be described.

In the above-described embodiment, the lens device 14 includes the zoom ring 28, and the engagement mechanism 60 is applied to the zoom ring 28 (see FIG. 4), but the engagement mechanism 60 may be applied to a rotation ring other than the zoom ring 28. In addition, the lens device 14 may include a movable member that is supported by the fixation frame 24 to be movable in the direction around the optical axis as an example of a “movable member” according to the technology of the present disclosure, and the engagement mechanism 60 may be applied to the movable member. In addition, the movable member may be a member that moves in any direction such as the optical axis direction.

In addition, in the above-described embodiment, the imaging apparatus 10 includes the attachment/detachment button 18, and the portion 18A of the attachment/detachment button 18 on the outer peripheral inclined surface 38 side is within the range R1 between the first end part 38A1 and the second end part 38A2 of the lens device 14 in the radial direction (see FIG. 2), but the imaging apparatus 10 may include an operation portion other than the attachment/detachment button 18, and at least a part of the operation portion may be within the range R1 between the first end part 38A1 and the second end part 38A2 of the lens device 14 in the radial direction. In addition, the operation portion may be any operation portion such as a switch for performing an operation on the setting of the imaging apparatus 10.

In addition, in the above-described embodiment, the part of the filtering 22 and the part of the inner barrel 54 are within the range R2 between the third end part 60A1 and the fourth end part 60A2 of the lens device 14 in the radial direction (see FIG. 15), but at least a part of other members supported by the fixation frame 24 may be within the range R2 between the third end part 60A1 and the fourth end part 60A2 of the lens device 14 in the radial direction in addition to the filtering 22 and the inner barrel 54.

FIG. 16 is a side cross-sectional view schematically showing a relationship between the peripheral wall portion 34 of the rear cover 30 according to the modification example and the engagement mechanism 60. As shown in FIG. 16, the outer peripheral inclined surface 38 of the rear cover 30 may be inclined with respect to the optical axis direction in such a manner that the first end part 38A1 is located on the inner side of the lens device 14 in the radial direction with respect to the second end part 38A2. Similarly, the inner peripheral inclined surface 44 of the rear cover 30 may be inclined with respect to the optical axis direction in such a manner that the first end part 44A1 is located on the inner side of the lens device 14 in the radial direction with respect to the second end part 44A2. Further, the engagement mechanism 60 may be inclined with respect to the optical axis direction in such a manner that the third end part 60A1 is located on the inner side of the lens device 14 in the radial direction with respect to the fourth end part 60A2.

In addition, the second support portion 98 that supports the biasing member 64 may be a member other than the rear cover 30.

The above contents and illustrations are detailed descriptions of the parts according to the technology of the present disclosure, and are merely examples of the technology of the present disclosure. For example, description of the above-described configurations, functions, actions, and effects is description related to an example of configurations, functions, actions, and effects of parts related to the present disclosed technology. Accordingly, in the contents described and the contents shown hereinabove, it is needless to say that removal of an unnecessary part, or addition or replacement of a new element may be employed within a range not departing from the gist of the present disclosed technology. In addition, in order to avoid complication and facilitate the understanding of a portion according to the technology of the present disclosure, regarding the contents described and shown above, description related to common technical knowledge or the like which does not need to be particularly described to enable implementation of the technology of the present disclosure is omitted.

What is claimed is:

1. A lens device comprising:
an optical system;
a support member that supports the optical system;
a movable member that is disposed along an outer periphery of the support member and that is movably supported with respect to the support member; and
an engagement mechanism that engages with the movable member,
wherein the engagement mechanism is inclined with respect to a direction of an optical axis.

2. The lens device according to claim 1,
wherein the movable member includes a rotation ring that is supported to be rotatable with respect to the support member in a direction around the optical axis.

3. The lens device according to claim 2,
wherein the optical system includes
a first optical system, and
a second optical system that is disposed on an object side with respect to the first optical system, and
the lens device includes an interlocking mechanism that moves the first optical system and the second optical system in the direction of the optical axis in response to rotation of the rotation ring.

4. The lens device according to claim 3,
wherein the movable member includes an engaged portion that is engaged with the engagement mechanism at a position at which the first optical system and the second optical system are accommodated in the support member.

5. The lens device according to claim 4,
wherein the position at which the first optical system and the second optical system are accommodated in the support member is a position at which both the first optical system and the second optical system are accommodated in the support member, and is a position corresponding to a retracted end.

6. The lens device according to claim 1,
wherein the engagement mechanism engages with the movable member along an engagement direction, and
the engagement direction is inclined with respect to the direction of the optical axis.

7. The lens device according to claim 1, further comprising:
a cover that covers the engagement mechanism,
wherein the cover includes an inclined surface that is inclined with respect to the direction of the optical axis, and
the engagement mechanism is inclined with respect to the direction of the optical axis in accordance with inclination of the inclined surface.

8. The lens device according to claim 7,
wherein the inclined surface includes a first end part that is located on an object side and a second end part that is located on an image forming side, and is inclined with respect to the direction of the optical axis in such a manner that the first end part is located on an outer side of the lens device in a radial direction with respect to the second end part.

9. The lens device according to claim 7,
wherein the cover includes a peripheral wall portion that has an outer peripheral surface and an inner peripheral surface, and
the inclined surface includes
an outer peripheral inclined surface formed on the outer peripheral surface, and
an inner peripheral inclined surface formed on the inner peripheral surface.

10. The lens device according to claim 1,
wherein the engagement mechanism includes
an engagement member that engages with the movable member, and
a biasing member that biases the engagement member toward a movable member side.

11. The lens device according to claim 1,
wherein the engagement mechanism includes a third end part that is located on an object side and a fourth end part that is located on an image forming side, and is inclined with respect to the direction of the optical axis in such a manner that the third end part is located on an outer side of the lens device in a radial direction with respect to the fourth end part.

12. The lens device according to claim 1, further comprising:
a plurality of the engagement mechanisms,
wherein the plurality of engagement mechanisms are provided at intervals in a direction around the optical axis.

13. The lens device according to claim 1,
wherein the engagement mechanism includes an engagement member that engages with the movable member,
the engagement member engages with the movable member along an inclination direction that is inclined with respect to the direction of the optical axis, and
the support member includes a first support portion that supports the engagement member to be movable in the inclination direction.

14. The lens device according to claim 13,
wherein the engagement member includes a supported portion that extends in the inclination direction, and
the first support portion supports the supported portion.

15. The lens device according to claim 14,
wherein the first support portion includes a groove portion into which the supported portion is inserted to be movable, the groove portion extending in the inclination direction.

16. The lens device according to claim 14,
wherein the engagement mechanism includes a third end part that is located on an object side and a fourth end part that is located on an image forming side and is inclined with respect to the direction of the optical axis in such a manner that the third end part is located on an outer side of the lens device in a radial direction with respect to the fourth end part, and
the first support portion includes a pressing portion that presses the supported portion from the outer side of the lens device in the radial direction with respect to the supported portion.

17. The lens device according to claim 14,
wherein the first support portion includes a pressing portion that presses the supported portion, the pressing portion extending in the direction of the optical axis.

18. The lens device according to claim 17,
wherein the pressing portion includes a line contact portion that is in line contact with the supported portion.

19. The lens device according to claim 14,
wherein the engagement member includes an engagement portion that engages with the movable member,
the supported portion includes a first supported portion and a second supported portion that are arranged in an intersection direction intersecting the inclination direction,
the engagement portion is located between the first supported portion and the second supported portion, and
the first support portion includes a first pressing portion and a second pressing portion that press the first supported portion and the second supported portion from an outer side of the lens device in a radial direction with respect to the first supported portion and the second supported portion.

20. The lens device according to claim 13,
wherein the first support portion includes a sliding surface that slides with the engagement member, the sliding surface extending in the inclination direction.

21. The lens device according to claim 1, further comprising:
a first support member as the support member; and
a second support member that is located on an image forming side with respect to the first support member,
wherein the engagement mechanism includes
an engagement member that engages with the movable member, and
a biasing member that biases the engagement member toward a movable member side,
the first support member includes a first support portion that supports the engagement member to be movable in an inclination direction that is inclined with respect to the direction of the optical axis, and
the second support member includes a second support portion that supports the biasing member.

22. The lens device according to claim 21,
wherein the second support portion includes a support surface that supports an end part of the biasing member on the image forming side, and
the support surface is a surface perpendicular to the inclination direction.

23. The lens device according to claim 21,
wherein the second support portion includes an accommodation portion that accommodates the biasing member,
the accommodation portion includes an opening portion that is open toward an engagement member side, and
the opening portion is enlarged in diameter toward the engagement member side.

24. The lens device according to claim 21,
wherein the biasing member includes a coil spring, and
the engagement member includes an insertion portion that is inserted into an inner side of the coil spring to support the coil spring.

25. The lens device according to claim 1, further comprising:
a supported member that is supported by the support member,
wherein the engagement mechanism includes a third end part that is located on an object side and a fourth end part that is located on an image forming side, and is inclined with respect to the direction of the optical axis in such a manner that the third end part is located on an outer side of the lens device in a radial direction with respect to the fourth end part, and
at least a part of the supported member is within a range between the third end part and the fourth end part in the radial direction of the lens device.

26. An imaging apparatus comprising:
the lens device according to claim 1; and
an imaging apparatus body to which the lens device is attached.

27. The imaging apparatus according to claim 26,
wherein the lens device includes a cover that covers the engagement mechanism,
the cover includes an inclined surface that is inclined with respect to the direction of the optical axis,
the inclined surface includes a first end part that is located on an object side and a second end part that is located on an image forming side, and is inclined with respect to the direction of the optical axis in such a manner that the first end part is located on an outer side of the lens device in a radial direction with respect to the second end part,
the imaging apparatus body includes an operation portion,
at least a part of the operation portion is within a range between the first end part and the second end part in the radial direction of the lens device, and
the engagement mechanism is inclined with respect to the direction of the optical axis in accordance with inclination of the inclined surface.
